(19) United States
(12) Patent Application Publication
(10) Pub. No.: US 2026/0079669 A1
(43) Pub. Date: Mar. 19, 2026

(54) SIGNAL PLAYING METHOD, DEVICE AND STORAGE MEDIUM

(71) Applicant: AAC Technologies Pte. Ltd., Singapore (SG)

(72) Inventor: Juha Backman, Tampere (FI)

(21) Appl. No.: 18/884,143

(22) Filed: Sep. 13, 2024

(51) Int. Cl. G06F 3/16; H04R 3/04

(52) U.S. Cl. CPC G06F 3/165; H04R 3/04

(57) ABSTRACT

Provided is a signal play method and device, and a storage medium. The method includes: detecting an acquired camera image and generating a detection result; generating a play signal according to an adjustment parameter and an acquired audio input signal, the adjustment parameter including the detection result; and playing according to the play signal, so that the computer device can automatically adjust the audio input signal to be played to generate a play signal, which improves the sound play effect and thus improving user experience.

### TECHNICAL FIELD

The present disclosure relates to the field of automatic sound technologies, and in particular, to a signal playing method and device, and a storage medium.

### BACKGROUND

In the related art, a loudspeaker of a laptop is typically installed in the body part of the device, the sound field created by the loudspeaker is highly irregular due to reflections from the display, the response is affected by both a listener position and an angle between the device body and the display, so equalizing the frequency response with a fixed equalizer response cannot produce a flat frequency response in all usage situations, which may result in poor sound play effects and thus reduces user experience.

### SUMMARY

In view of this, the present disclosure provides a signal playing method and device, a storage medium and a computer device, so as to solve the problem of poor sound playing effect and reduced user experience in the related art.

In a first aspect, an embodiment of the present disclosure provides a method for playing a signal, including: detecting an acquired camera image and generating a detection result; generating a play signal according to an adjustment parameter and an acquired audio input signal, the adjustment parameter includes the detection result; and playing according to the play signal.

As an improvement, before the generating the play signal according to the adjustment parameter and the acquired audio input signal, the method further includes: acquiring a device opening parameter. The adjustment parameter further includes the device opening parameter, and the play signal includes a first play signal; and the generating the play signal according to the detection result and the acquired audio input signal includes: determining a first equalizer parameter according to the device opening parameter and the detection result; and adjusting the audio input signal according to the first equalizer parameter to generate the first play signal.

As an improvement, the play signal includes a second play signal, and the generating the play signal according to the adjustment parameter and the acquired audio input signal includes: determining a second equalizer parameter according to the detection result; and adjusting the audio input signal according to the second equalizer parameter to generate the second play signal.

As an improvement, the detecting the acquired camera image and generating the detection result includes: detecting the camera image by a recognition algorithm to generate a detection result.

As an improvement, the detection result includes a relative position parameter.

As an improvement, the recognition algorithm includes a face recognition algorithm.

In a second aspect, an embodiment of the present disclosure provides a signal play device, including: a first generation module configured to detect an acquired camera image and generate a detection result; a second generation module configured to generate a play signal according to an adjustment parameter and an acquired audio input signal, the adjustment parameter includes the detection result; and a playing module configured to play according to the play signal.

In a third aspect, an embodiment of the present disclosure provides a computer device, including a memory storing computer program instructions and a processor for executing the program instructions, when the computer program instructions are executed by the processor, the computer device executes any one of the methods described in the first aspect.

In a fourth aspect, an embodiment of the present disclosure provides a non-transitory computer-readable storage medium, including a stored program, when the program is executed, a device where the computer-readable storage medium is located is controlled to execute any one of the methods described in the first aspect.

In a fifth aspect, an embodiment of the present disclosure provides a computer program product, the computer program product includes executable instructions, and when the executable instructions are executed on a computer, the computer is enabled to execute any one of the methods described in the first aspect.

Embodiments of the present disclosure provide a signal play method and device, a storage medium and a computer device, which detect an acquired camera image and generate a detection result; generate a play signal according to adjustment parameters and an acquired audio input signal, the adjustment parameters include the detection result; and play according to the play signal, so that the computer device can automatically adjust the audio input signal to be played and generate a play signal, thereby improving the sound play effect and user experience.

### BRIEF DESCRIPTION OF DRAWINGS

In order to better illustrate the technical solutions of embodiments of the present disclosure, the drawings required for use in the embodiments will be introduced below. It is apparent that, the drawings described below are only some embodiments of the present disclosure. For person of ordinary skill in the art, other drawings can be obtained based on these drawings without creative efforts.

FIG. 1 is a flow chart of a signal playing method according to an embodiment of the present disclosure;

FIG. 2 is a schematic diagram of detection according to an embodiment of the present disclosure;

FIG. 3 is a flow chart of generating a first play signal according to an embodiment of the present disclosure;

FIG. 4a is a schematic diagram of a high-frequency sound field distribution around device according to an embodiment of the present disclosure;

FIG. 4b is a schematic diagram of a high-frequency sound field distribution around device according to another embodiment of the present disclosure;

FIG. 5a is a schematic diagram of a frequency distribution according to an embodiment of the present disclosure;

FIG. 5b is a schematic diagram of a frequency distribution according to another embodiment of the present disclosure;

FIG. 6 is a schematic diagram of an implementation of a partial response of an equalizer according to an embodiment of the present disclosure;

FIG. 7 is a flow chart of generating a second play signal according to an embodiment of the present disclosure;

FIG. 8 is a schematic structural diagram of a signal play device according to an embodiment of the present disclosure; and

FIG. 9 is a schematic structural diagram of a computer device according to an embodiment of the present disclosure.

### DESCRIPTION OF EMBODIMENTS

In order to better understand the technical solution of the present disclosure, embodiments of the present disclosure are described in detail below with reference to the accompanying drawings.

It should be clear that the described embodiments are only some embodiments of the present disclosure, not all of the embodiments. Based on the embodiments of the present disclosure, all other embodiments obtained by person of ordinary skill in the art without creative efforts are within the scope of protection of the present disclosure.

In embodiments of the present disclosure, terms used are only for the purpose of describing specific embodiments, and are not intended to limit the present disclosure. The singular forms “a/an”, “said” and “the” used in embodiments of the present disclosure and the appended claims are also intended to include plural forms, unless the context clearly indicates otherwise.

It should be understood that the term “and/or” used in the present disclosure is only a description of the relationship of associated objects, indicating that there can be three relationships. For example, A and/or B can represent: A exists alone, A and B exist at the same time, and B exists alone. In addition, the character “/” in the present disclosure generally indicates that the associated objects before and after are in an “or” relationship.

In the related art, the user's ears can be detected through acoustic detection or optical detection to adjust the audio level and/or response. Alternatively, the play device can switch the audio play mode according to the mode set by the user, but the sound play effect is generally poor, which reduces user's experience.

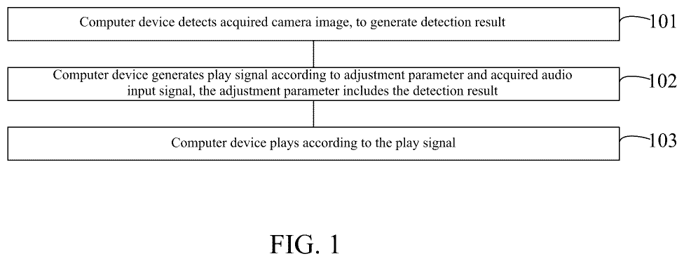

In order to improve the sound playing effect and improve the user's experience, FIG. 1 is a flow chart of a signal playing method according to an embodiment of the present disclosure. As shown in FIG. 1, the method includes:

Step 101: a computer device detects an acquired camera image to generate a detection result.

In some embodiments, the computer device includes but is not limited to a laptop computer, a desktop computer, foldable devices such as a foldable phone, a flip phone, or the like. The computer device includes a camera, which may be integrated in the computer device or connected to the computer device via a wired and/or wireless connection. The camera captures a camera image. The computer device detects the camera image to determine whether the camera image includes a human face image. The human face image includes an image of a certain part of the human face or an image of the entire human face, or the like.

Step 102: the computer device generates a play signal according to an adjustment parameter and an acquired audio input signal, the adjustment parameter includes the detection result.

In some embodiments, the computer device adjusts the audio input signal according to the adjustment parameter. For example, the adjustment includes an equalization adjustment. The audio input signal can be a music signal, a game signal, a media signal, a consumer signal, a video sound signal or a voice signal.

Step 103: the computer device plays according to the play signal.

In some embodiments, the computer device further includes an audio amplifier and a speaker. The audio amplifier and the speaker can be used for playing the play signal.

Embodiments of the present disclosure provide a signal play method, which detects an acquired camera image and generates a detection result; generates a play signal according to adjustment parameters and an acquired audio input signal, and the adjustment parameters include the detection result; plays according to the play signal, so that the computer device can automatically adjust the audio input signal to be played and generate a play signal, thereby improving the sound play effect and user experience.

In an embodiment, step 101 may specifically include: the computer device detects the camera image through a recognition algorithm to generate a detection result.

In some embodiments, the computer device detects the camera image through a recognition algorithm to detect whether the camera image includes a human face image. After detecting that the camera image includes a human face image, a relative position parameter is generated based on the camera image including the human face image. The detection result includes the relative position parameter, and the relative position parameter includes the orientation, position and/or distance of the human face relative to the camera. The detection result may further include the human face image. After the computer device does not detect any human face image in the camera image, the computer device generates a detection result based on the fact that the camera image does not include the human face image, and the detection result includes: the camera image does not include the human face image. Thus, human face detection can be performed through the recognition algorithm to obtain the relative position parameters between the human face and the computer device. For example, when the computer devices detects from the camera image body parts such as neck, trunk, shoulder and the like, it can determine the position of the human face from the detected neck, trunk and shoulder, and accordingly adjust the equalizer according to an estimated position of the human ears (which may be located on the central normal axis of the display).

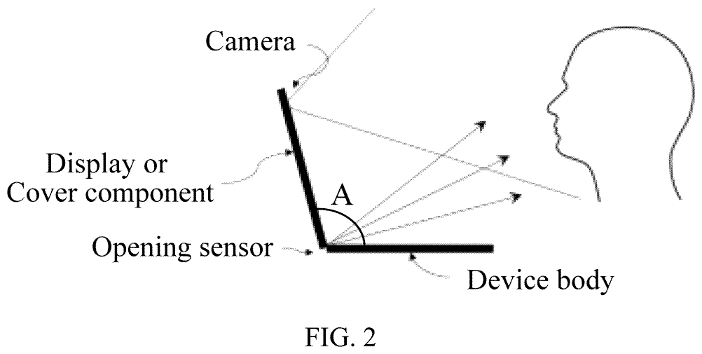

FIG. 2 is a schematic diagram of detection according to an embodiment of the present disclosure. As shown in FIG. 2, the computer device is a laptop computer, and the laptop computer includes a camera, a device body, a display or cover component, and an opening sensor. The display or cover part and the device body can be connected by a hinge, and the opening angle A is the angle between the display or cover part and the device body. The recognition algorithm includes a face recognition algorithm, and the laptop computer further includes a face detection module. The camera collects a camera image, and the face detection module detects the camera image and determines that the camera image includes a face image.

If the speaker is connected to the computer device via wired and/or wireless connection, when the computer device detects the camera image through the recognition algorithm, it can further detect whether the camera image includes the speaker image. When it is detected that the camera image includes the speaker image, the relative angle parameter is calculated according to the speaker image, and the detection result further includes the relative angle parameter. The relative angle parameter includes the angle between the speaker and the reflection plane.

In an embodiment, before Step 102, the following steps are further included: Step 100, the computer device obtains the opening parameter, and the adjustment parameter further includes the device opening parameter.

In some embodiments, the speaker is integrated on the computer device, and the computer device further includes an opening sensor, which is used to collect device opening parameters. The device opening parameters include the angle between the device body and the display or cover part. As shown in FIG. 2, the speaker is integrated on the laptop computer, and the reflection of the sound from the display or cover part and the device body causes an irregular sound field, so the change of the geometric shape and the listening position has an impact on the sound frequency, and the device opening parameters include the opening angle A.

When the speaker is connected through wired or wireless manners, the opening angle should be interpreted as the angle between the speaker and the surface on which it is placed, this may be fixed by the design. If the actual value of the device opening parameter is not available, then a default value corresponding to typical usage should be substituted (i.e., an average value of the opening angle of a laptop display could be used). Alternatively, if an adjustable base is provided, then the base should include a detection mechanism, such as a sensor. The reading of this sensor can be returned to the source device through the connecting interface (such as USB or Bluetooth), or the equalization function can be performed locally in the speaker.

In some embodiments, if the camera is blocked or disabled, the use of the equalization principle is also allowed in the devices such as external displays with speakers where no camera is available. If used with an external display device, the display usually has a stand placing it to a certain distance away from the table surface. This height, in addition to the tilt angle of the display, shall also be used as an additional adjustable parameter.

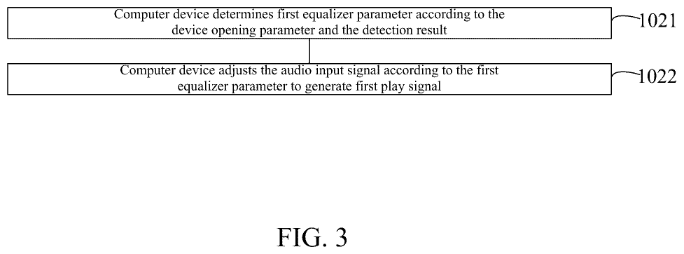

FIG. 3 is a flow chart of generating a first play signal according to an embodiment of the present disclosure. As shown in FIG. 3, step 102 may specifically include:

Step 1021: the computer device determines a first equalizer parameter according to the device opening parameter and the detection result.

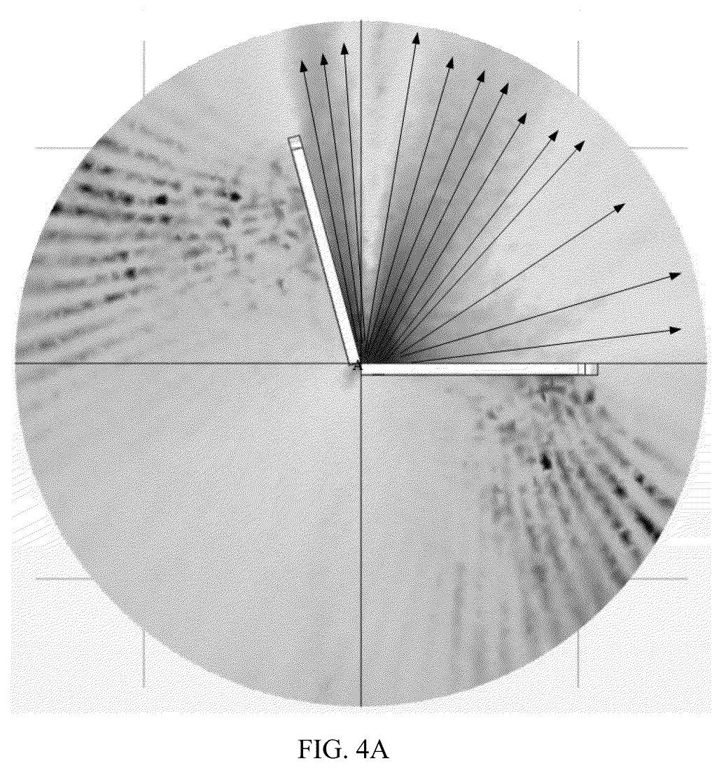

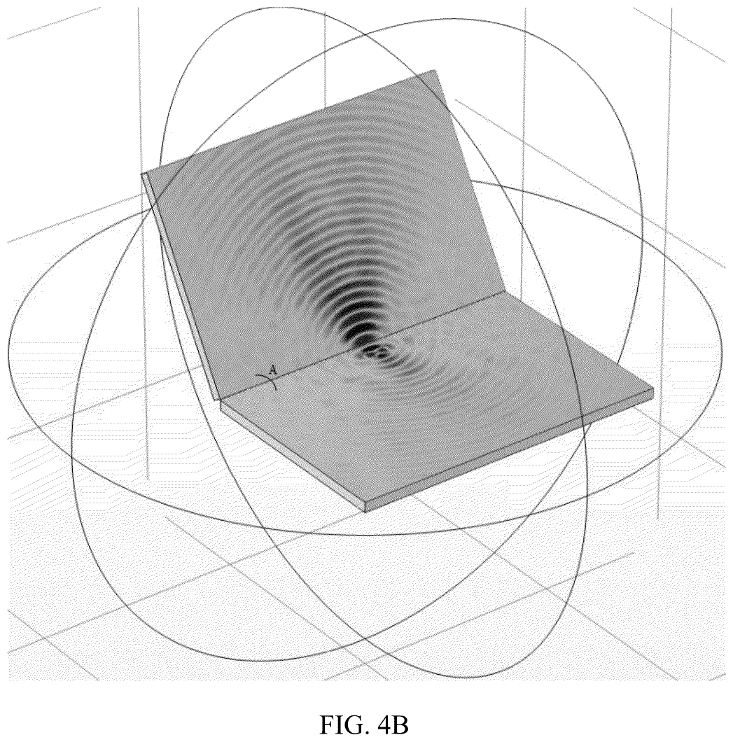

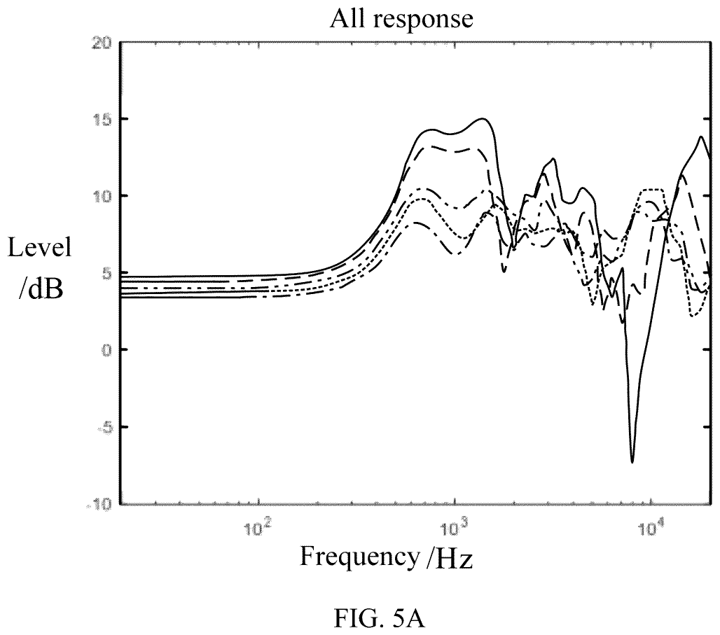

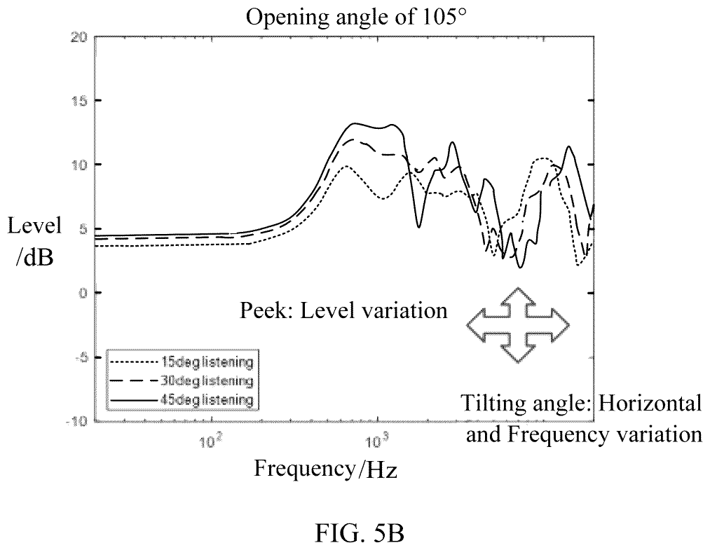

In some embodiments, FIG. 4a is a schematic diagram of the high-frequency sound field distribution around device according to an embodiment of the present disclosure, and FIG. 4b is a schematic diagram of the high-frequency sound field distribution around device according to another embodiment of the present disclosure. As shown in FIG. 4a and FIG. 4b, the high frequency refers to 10 kHz. The computer device includes laptops. The angle between the screen and keyboard of the laptop is defined as the opening angle A. The sound frequency around the laptop is affected by the opening angle A of the laptop. The sound frequency of the space corresponding to the laptop opening angle A is greater than the sound frequency of other spaces. The relative position parameter includes the listener's position. FIG. 5a is a schematic diagram of frequency distribution according to an embodiment of the present disclosure. FIG. 5a shows various frequency response changes when the opening angle and the listener's position change, the simulated frequency response shows the effect of changes of the opening angle and the listener position on the frequency response of the computer device. The frequency response produces significant changes over a wide range, and an attempt is made to correct the response with a fixed equalizer corresponding to an average frequency response. FIG. 5b is a schematic diagram of frequency distribution according to another embodiment of the present disclosure. FIG. 5b shows the frequency response changes when the opening angle is 105 degrees with listening direction elevation angles of 15, 30 and 45 degrees, and with the only change of the listener's position. In FIG. 5b, the horizontal axis is frequency, and the unit of frequency is Hertz (Hz); the vertical axis is level, and the unit of level is decibel (dB).

Since the reflection of sound from the display or cover part and the device body causes an irregular sound field, the frequency distribution around the computer device depends on the device opening parameters and position relative parameters.

In embodiments of the present disclosure, the adjustment parameter may further include device information of the computer device, initial information of the equalizer, etc., and the adjustment parameter is not limited in the embodiments of the present disclosure. Step 1021 may further include: the computer device determines the first equalizer parameter according to the device information and/or initial information, the device opening parameter and the detection result.

Step 1022: the computer device adjusts the audio input signal according to the first equalizer parameter to generate a first play signal.

In some embodiments, the computer device further includes an equalizer, and the equalizer is used to adjust the audio input signal. For example, the equalizer includes a high-order equalizer and/or a tilt equalizer. The equalizer is adjusted according to the first equalizer parameter, and the adjusted equalizer adjusts the audio input signal to adjust the frequency and/or level of the audio input signal. The adjusted audio input signal is used as the first play signal.

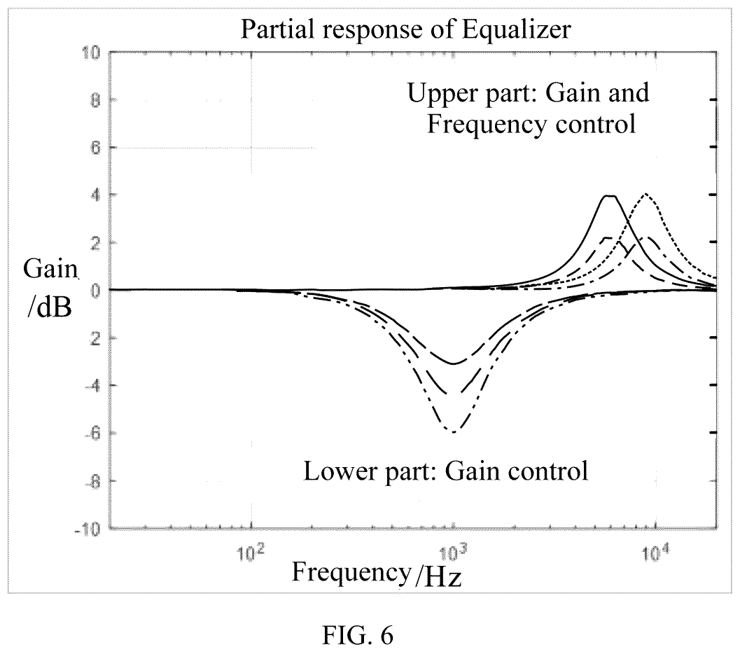

The simplest feasible equalizer is composed of two equalizer modules. For example, the simplest adjustable equalizer sufficient to control the frequency response is composed of two second-order bi-quad equalizer modules. FIG. 6 is a schematic diagram of an implementation of a partial response of an equalizer according to an embodiment of the present disclosure. FIG. 6 shows the adjustment of the signal when two equalizer modules are used. The horizontal axis is the frequency, and the unit of frequency is Hertz (Hz). The vertical axis is the gain, and the unit of gain is decibel (dB). Taking the gain of 0 dB as the reference line, the upper part with a gain above 0 dB is used as the gain and frequency control, and the equalizer will perform gain and frequency control on the signal. The lower part with a gain below 0 dB is used as the gain control, and the equalizer will perform gain control on the signal.

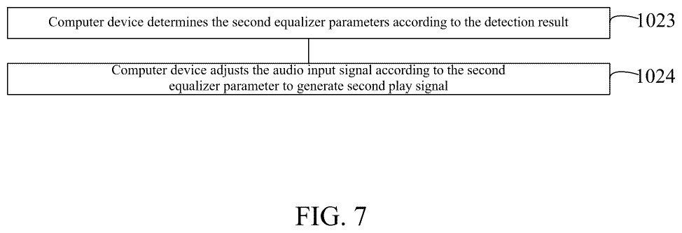

In an embodiment, the play signal includes a second play signal. FIG. 7 is a flow chart of generating a second play signal according to an embodiment of the present disclosure. As shown in FIG. 7, step 102 may specifically include:

Step 1023: the computer device determines the second equalizer parameters according to the detection result.

In some embodiments, the detection result includes a relative position parameter and a relative angle parameter.

In some embodiments, the adjustment parameters may further include device information of the computer device, initial information of the equalizer, etc., and the adjustment parameters are not limited in the embodiments of the present disclosure. Step 1023 may further include: the computer device determines the second equalizer parameter according to the device information and/or initial information, and the detection result. Explanations for Step 1023 may refer to those for the above Step 1021.

Step 1024: The computer device adjusts the audio input signal according to the second equalizer parameter to generate a second play signal.

In some embodiments, Explanations for Step 1024 may refer to those for the above Step 1022.

Embodiments of the present disclosure provide a signal play method, which detects the acquired camera image and generates a detection result; generates a play signal according to adjustment parameters and the acquired audio input signal, and the adjustment parameters include the detection result; plays according to the play signal, so that the computer device obtains the detection result by recognizing and detecting the camera image in real time, and then automatically adjusts the audio input signal to be played based on the adjustment parameters including the detection result, to generate a play signal, so that users can have good listening effects in different positions, thereby improving the sound play effect, and improving user experience.

The technical solutions of the present disclosure may be applied to a device such as a laptop computer that has a body part, another part such as display that are connected with an adjustable hinge. The device has a camera oriented towards the user, and a sensor capable of reading the angle between the two device parts. Through the face detection algorithm and a method for combining the information about the user's position and the geometric configuration of the device to control parameters, which are used to adjust an audio equalizer, which enables precise equalization of laptop computer speakers, and is applicable to a broad range of desktop speakers.

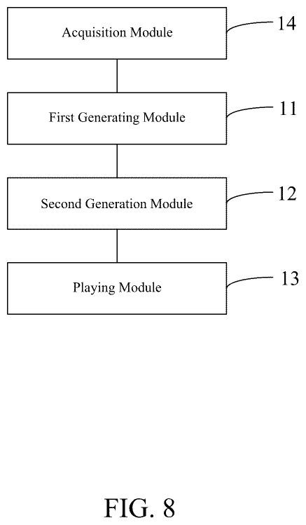

FIG. 8 is a schematic structural diagram of a signal play device according to an embodiment of the present disclosure. As shown in FIG. 8, the device includes a first generation module 11, a second generation module 12 and a play module 13. The first generation module 11 is connected to the second generation module 12, and the second generation module 12 is connected to the play module 13.

The first generation module 11 is configured to detect the acquired camera image and generate a detection result. The second generation module 12 is configured to generate a play signal according to adjustment parameters and the acquired audio input signal. The adjustment parameters include the detection result. The play module 13 is configured to play according to the play signal.

In an embodiment, the device further includes an acquisition module 14, and the acquisition module 14 is connected to the first generation module 11.

The acquisition module 14 is configured to obtain the device opening parameter. The adjustment parameter further includes the device opening parameter, and the play signal includes a first play signal. The first generation module 11 is specifically configured to determine the first equalizer parameter according to the device opening parameter and the detection result; and adjust the audio input signal according to the first equalizer parameter to generate the first play signal.

In an embodiment, the play signal includes a second play signal; the first generation module 11 is specifically configured to determine a second equalizer parameter according to the detection result; and adjust the audio input signal according to the second equalizer parameter to generate the second play signal.

In an embodiment, the second generation module 12 is specifically configured to detect the camera image by a recognition algorithm to generate a detection result.

In an embodiment, the detection result includes a relative position parameter.

In an embodiment, the recognition algorithm includes a face recognition algorithm.

Embodiments of the present disclosure provide a signal play device, which detects an acquired camera image and generates a detection result; generates a play signal according to adjustment parameters and an acquired audio input signal, the adjustment parameters include the detection result; and plays according to the play signal, so that a computer device can automatically adjust the audio input signal to be played and generate a play signal, thereby improving the sound play effect and user experience.

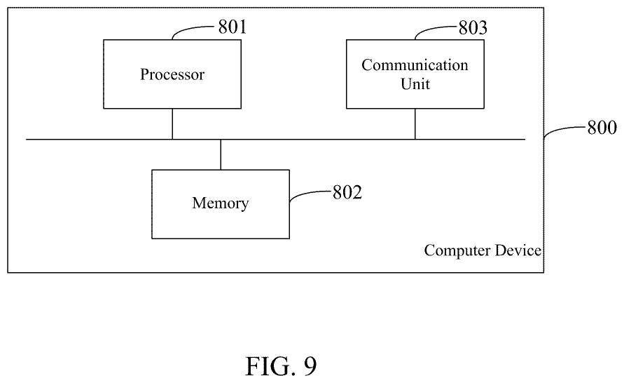

Corresponding to the above-mentioned embodiment, the present disclosure further provides a computer device. FIG. 9 is a schematic structural diagram of a computer device according to an embodiment of the present disclosure. The computer device 800 may include: a processor 801, a memory 802, and a communication unit 803. These components communicate via one or more buses, and person of ordinary skill in the art may understand that the structure of the computer device shown in the figures does not constitute any limitation on the embodiments of the present disclosure, and it may be formed as a bus structure or a star structure, and may also include more or fewer components than shown in the figures, or combine certain components, or arrange the components differently.

The communication unit 803 is configured to establish a communication channel so that the computer device can communicate with other devices, receive user data sent by other devices or send user data to other devices.

The processor 801 is the control center of the computer device. It uses various interfaces and lines to connect various parts of the entire computer device. It runs or executes software programs, instructions, and/or modules stored in the memory 802, and calls data stored in the memory to perform various functions of the computer device and/or process data. The processor can be composed of an integrated circuit (IC). For example, it can be composed of a single packaged IC, or it can be composed of multiple packaged ICs with the same or different functions. For example, the processor 801 can only include a central processing unit (CPU). In an embodiment of the present disclosure, the CPU can be a single computing core or multiple computing cores.

The memory 802 is configured to store the execution instructions of the processor 801. The memory 802 can be implemented by any type of transitory or non-transitory storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

When the execution instructions in the memory 802 are executed by the processor 801, the computer device 800 is enabled to execute part or all of the steps in the embodiments shown in FIG. 1.

In some embodiments, the present disclosure further provides a computer storage medium. The computer storage medium may store a program, and when the program is executed, the program may include some or all of the steps in each embodiment of the signal play method according to the present disclosure. The storage medium may be a magnetic disk, an optical disk, a read-only memory (ROM) or a random access memory (RAM), etc.

In some embodiments, the present disclosure further provides a computer program product. The computer program product includes executable instructions, and when the executable instructions are executed on a computer, the computer executes part or all of the steps in each embodiment of the signal play method according to the present disclosure.

Person of ordinary skill in the art can clearly understand that the technology in the embodiments of the present disclosure can be implemented by means of software plus a necessary general hardware platform. Based on this understanding, the technical solution in the embodiments of the present disclosure is essentially or the part that contributes to the related art can be embodied in the form of a software product, which can be stored in a storage medium such as ROM/RAM, a magnetic disk, an optical disk, etc., and includes a number of instructions for a computer device (which can be a personal computer, a server, or a network device, etc.) to execute the methods described in the various embodiments of the present disclosure or some parts of the embodiments.

In this specification, the same or similar parts between the various embodiments can be referred to each other. In particular, for the device embodiments and the terminal embodiments, since they are basically similar to the method embodiments, the description is relatively simple, and the relevant parts can be referred to the description in the method embodiments.

What is claimed is:

1. A signal playing method, comprising:
detecting an acquired camera image and generating a detection result;
generating a play signal according to an adjustment parameter and an acquired audio input signal, wherein the adjustment parameter includes the detection result; and
playing according to the play signal.

2. The method as described in claim 1, wherein before the generating the play signal according to the adjustment parameter and the acquired audio input signal, the method further comprises:
acquiring a device opening parameter;
wherein the adjustment parameter further includes the device opening parameter, and the play signal includes a first play signal; and the generating the play signal according to the detection result and the acquired audio input signal comprises:
determining a first equalizer parameter according to the device opening parameter and the detection result; and
adjusting the audio input signal according to the first equalizer parameter to generate the first play signal.

3. The method as described in claim 1, wherein the play signal comprises a second play signal, and the generating the play signal according to the adjustment parameter and the acquired audio input signal comprises:
determining a second equalizer parameter according to the detection result; and
adjusting the audio input signal according to the second equalizer parameter to generate the second play signal.

4. The method as described in claim 1, wherein the detecting the acquired camera image and generating the detection result comprises:
detecting the camera image by a recognition algorithm to generate a detection result.

5. The method as described in claim 4, wherein the detection result includes a relative position parameter.

6. The method as described in claim 4, wherein the recognition algorithm includes a face recognition algorithm.

7. A signal play device, comprising:
a first generation module configured to detect an acquired camera image and generate a detection result;
a second generation module configured to generate a play signal according to an adjustment parameter and an acquired audio input signal, wherein the adjustment parameter includes the detection result; and
a playing module configured to play according to the play signal.

8. A non-transitory computer-readable storage medium, comprising a stored program, wherein when the program is executed, a device where the computer-readable storage medium is located is controlled to execute the method according to claim 1.
